(19) United States
(12) Patent Application Publication
(10) Pub. No.: US 2024/0176988 A1
(43) Pub. Date: May 30, 2024

(54) GENERATING LOW-DISTORTION, IN-DISTRIBUTION NEIGHBORHOOD SAMPLES OF AN INSTANCE OF A DATASET USING A VARIATIONAL AUTOENCODER

(71) Applicant: International Business Machines Corporation, Armonk, NY (US)

(72) Inventors: Natalia Martinez Gil, Durham, NC (US); Kanthi Sarpatwar, Elmsford, NY (US); Roman Vaculin, Larchmont, NY (US)

(21) Appl. No.: 18/070,388

(22) Filed: Nov. 28, 2022

(51) Int. Cl. G06N 3/0455; G06N 3/044; G06N 3/047

(52) U.S. Cl. CPC G06N 3/0455; G06N 3/044; G06N 3/047

(57) ABSTRACT

A computer-implemented method, system and computer program product for utilizing a variational autoencoder for neighborhood sampling. A variational autoencoder is trained to generate in-distribution neighborhood samples. Upon training the variational autoencoder to generate in-distribution neighborhood samples, in-distribution neighborhood samples of an instance of a dataset in latent space that satisfy a distortion constraint are generated using the trained variational autoencoder. A set of interpretable examples for the in-distribution neighborhood samples are then generated using a k-nearest neighbors algorithm. Such interpretable examples are then used to explain the black box model's predictions. As a result, the accuracy of the decision making ability of post-hoc local explanation methods is improved.

### TECHNICAL FIELD

The present disclosure relates generally to artificial intelligence methods, and more particularly to generating low-distortion, in-distribution neighborhood samples of an instance of a dataset (e.g., multi-dimensional data, such as time-series data and image data) using a variational autoencoder, where perturbations of such in-distribution neighborhood samples capture correlations between the features (e.g., time points) of the in-distribution neighborhood samples.

### BACKGROUND

Black box artificial intelligence (AI) methods (e.g., deep neural networks) have been widely utilized to build predictive models that can extract complex relationships in a dataset and make predictions for new unseen data records. However, it is difficult to trust decisions made by such methods since their inner working and decision logic are hidden from the user. Post-hoc local explanation methods approximate the behavior of a black box by extracting the relationships between feature values and the predictions.

An example of a post-hoc local explanation method is the local interpretable model-agnostic explanation (LIME) method. LIME is a method that fits a surrogate glassbox model around the decision space of any black box model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the black box model behaves in that region.

LIME works by perturbing any individual datapoint (perturbations correspond to small changes in the system, such as small changes in the gradients, weights, inputs, etc) and generating synthetic data which gets evaluated by the black box system, and ultimately used as a training set for the glassbox model. LIME's advantages are that you can interpret an explanation the same way you reason about a linear model, and that it can be used on almost any model.

Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method.

Furthermore, while such neighborhood distributions are inherently interpretable, the explanations generated may not capture the correlated behaviors of the model. As a result, the correlations between the features (e.g., features created from a time stamp value of an observation) of a neighborhood distribution may not be effectively captured.

By not effectively capturing the correlations between the features of the neighborhood distribution, a set of interpretable examples for the in-distribution neighborhood samples cannot be generated in order to explain the black box model's predictions.

As a result, there is not currently a means for generating in-distribution samples of a dataset, such as time-series or image data, for the neighborhood distribution to be used by the post-hoc local explanation methods. Furthermore, there is not currently a means for effectively capturing the correlations between the features of the neighborhood distribution or effectively generating a set of representative in-distribution examples in order to explain the black box model's predictions.

### SUMMARY

In one embodiment of the present disclosure, a computer-implemented method for utilizing a variational autoencoder for neighborhood sampling comprises training the variational autoencoder to generate in-distribution neighborhood samples. The method further comprises generating, using the trained variational autoencoder, in-distribution neighborhood samples of an instance of a dataset in a latent space that satisfies a distortion constraint. The method additionally comprises generating a set of interpretable examples for the in-distribution neighborhood samples using a k-nearest neighbors algorithm.

In this manner, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of the post-hoc local explanation method is improved.

In another embodiment of the present disclosure, a computer program product for utilizing a variational autoencoder for neighborhood sampling, where the computer program product comprises one or more computer readable storage mediums having program code embodied therewith, where the program code comprising programming instructions for training the variational autoencoder to generate in-distribution neighborhood samples. The program code further comprises the programming instructions for generating, using the trained variational autoencoder, in-distribution neighborhood samples of an instance of a dataset in a latent space that satisfies a distortion constraint. The program code additionally comprises the programming instructions for generating a set of interpretable examples for the in-distribution neighborhood samples using a k-nearest neighbors algorithm.

In this manner, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of the post-hoc local explanation method is improved.

In a further embodiment of the present disclosure, a system comprises a memory for storing a computer program for utilizing a variational autoencoder for neighborhood sampling. The processor is configured to execute program instructions of the computer program comprising training the variational autoencoder to generate in-distribution neighborhood samples. The processor is further configured to execute the program instructions of the computer program comprising generating, using the trained variational autoencoder, in-distribution neighborhood samples of an instance of a dataset in a latent space that satisfies a distortion constraint. The processor is additionally configured to execute the program instructions of the computer program comprising generating a set of interpretable examples for the in-distribution neighborhood samples using a k-nearest neighbors algorithm.

In this manner, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of the post-hoc local explanation method is improved.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates an embodiment of the present disclosure of the architecture of a variational autoencoder;

FIG. 3 is a diagram of the software components of the in-distribution sample generator used to generate the in-distribution samples of data for a neighborhood distribution to be used by post-hoc local explanation methods in accordance with an embodiment of the present disclosure;

FIG. 4 illustrates the in-distribution neighborhood samples of the instance of the dataset in accordance with an embodiment of the present disclosure;

FIG. 5 illustrates a representative example-based explanation for a 10-digit classifier in accordance with an embodiment of the present disclosure;

FIG. 6 illustrates an embodiment of the present disclosure of the hardware configuration of the in-distribution sample generator which is representative of a hardware environment for practicing the present disclosure;

FIG. 7 is a flowchart of a method for utilizing a variational autoencoder for neighborhood sampling in accordance with an embodiment of the present disclosure;

FIG. 8 is a flowchart of a method for training the variational autoencoder to generate in-distribution neighborhood samples of an instance of a dataset in latent space that satisfies a distortion constraint in accordance with an embodiment of the present disclosure;

FIG. 9 is a flowchart of a method for generating local neighborhoods that satisfy a distortion constraint in accordance with an embodiment of the present disclosure; and

FIG. 10 is a flowchart of a method for generating a set of representative in-distribution examples in accordance with an embodiment of the present disclosure.

### DETAILED DESCRIPTION

As stated in the Background section, an example of a post-hoc local explanation method is the local interpretable model-agnostic explanation (LIME) method. LIME is a method that fits a surrogate glassbox model around the decision space of any black box model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the black box model behaves in that region. LIME works by perturbing any individual datapoint (perturbations correspond to small changes in the system, such as small changes in the gradients, weights, inputs, etc.) and generating synthetic data which gets evaluated by the black box system, and ultimately used as a training set for the glassbox model. LIME's advantages are that you can interpret an explanation the same way you reason about a linear model, and that it can be used on almost any model. Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method. Furthermore, while such neighborhood distributions are inherently interpretable, the explanations generated may not capture the correlated behaviors of the model. As a result, the correlations between the features (e.g., features created from a time stamp value of an observation) of a neighborhood distribution may not be effectively captured. By not effectively capturing the correlations between the features of the neighborhood distribution, a set of interpretable examples for the in-distribution neighborhood samples cannot be generated in order to explain the black box model's predictions. As a result, there is not currently a means for generating in-distribution samples of a dataset, such as time-series or image data, for the neighborhood distribution to be used by the post-hoc local explanation methods. Furthermore, there is not currently a means for effectively capturing the correlations between the features of the neighborhood distribution or effectively generating a set of representative in-distribution examples in order to explain the black box model's predictions.

The embodiments of the present disclosure provide a means for generating low-distortion, in-distribution neighborhood samples of an instance of a dataset (e.g., multi-dimensional data, such as time-series data and image data) by utilizing a variational autoencoder. Furthermore, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of the post-hoc local explanation method is improved. These and other features will be discussed in further detail below.

In some embodiments of the present disclosure, the present disclosure comprises a computer-implemented method, system and computer program product for utilizing a variational autoencoder for neighborhood sampling. In one embodiment of the present disclosure, a variational autoencoder is trained to generate in-distribution neighborhood samples. A “variational autoencoder,” as used herein, refers to an artificial neural network architecture which allows statistical inference problems (such as inferring the value of one random variable from another random variable) to be rewritten as statistical optimization problems (i.e., identify the parameter values that minimize an objective function). Variational autoencoders map the input variable to a multivariate latent distribution. In particular, the input data is sampled from a parametrized distribution, and the encoder and decoder are trained jointly such that the output minimizes a reconstruction error. Upon training the variational autoencoder to generate in-distribution neighborhood samples, in-distribution neighborhood samples of an instance of a dataset in latent space that satisfy a distortion constraint are generated using the trained variational autoencoder. A set of interpretable examples for the in-distribution neighborhood samples are then generated using a k-nearest neighbors algorithm. Such interpretable examples are then used to explain the black box model's predictions. As a result, the accuracy of the decision making ability of post-hoc local explanation methods is improved.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

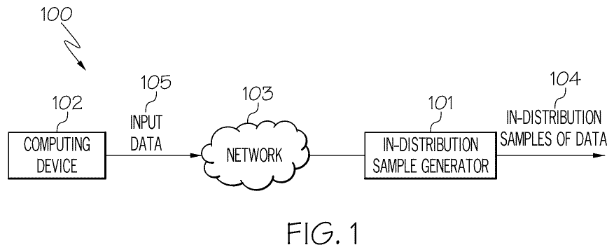

Referring now to the Figures in detail, FIG. 1 illustrates an embodiment of the present disclosure of a communication system 100 for practicing the principles of the present disclosure. Communication system 100 includes an in-distribution sample generator 101 connected to a computing device 102 via a network 103. In one embodiment, in-distribution sample generator 101 is configured to generate in-distribution samples of data 104 for a neighborhood distribution to be used by post-hoc local explanation methods using input data 105 (e.g., time series data, image data) provided by a user of computing device 102 as discussed in further detail below.

Computing device 102 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 102 and in-distribution sample generator 101. It is noted that both computing device 102 and the user of computing device 102 may be identified with element number 102.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

As discussed above, in-distribution sample generator 101 is configured to generate in-distribution samples of data 104 for a neighborhood distribution to be used by post-hoc local explanation methods using input data 105 (e.g., time series data, image data) provided by a user of computing device 102. In one embodiment, such in-distribution samples of data 104 for a neighborhood distribution to be used by post-hoc local explanation methods (e.g., local interpretable model-agnostic explanation method) are generated using a variational autoencoder. A “variational autoencoder,” as used herein, refers to an artificial neural network architecture which allows statistical inference problems (such as inferring the value of one random variable from another random variable) to be rewritten as statistical optimization problems (i.e., identify the parameter values that minimize an objective function). Variational autoencoders map the input variable to a multivariate latent distribution. In particular, the input data is sampled from a parametrized distribution, and the encoder and decoder are trained jointly such that the output minimizes a reconstruction error.

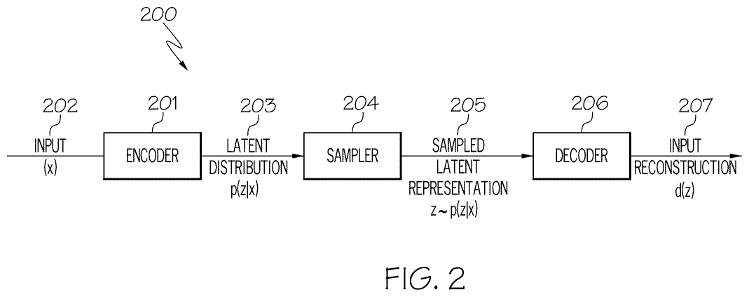

An illustration of a variational autoencoder is shown in FIG. 2.

Referring to FIG. 2, FIG. 2 illustrates an embodiment of the present disclosure of the architecture of a variational autoencoder 200. As shown in FIG. 2, variational autoencoder 200 includes an encoder 201 configured to encode an input (x) 202, such as multi-dimensional data (e.g., time series data, image data). Such encoding involves mapping the input data (x) 202 into a latent dimension or latent space forming a latent distribution (p(z|x)) 203. A “latent dimension” or a “latent space,” as used herein, refers to a representation of compressed data in which similar data points are closer together in space. Latent space is useful for learning data features and for finding simpler representations of data for analysis. That is, latent space refers to an abstract multi-dimensional space containing feature values that cannot be interpreted directly, but which encodes a meaningful internal representation of externally observed events. Such feature values are referred to as “latent codes.”

Furthermore, as shown in FIG. 2, variational autoencoder 200 includes a sampler 204 configured to sample the latent distribution 203 forming a sampled latent representation 205 (z˜p(z|x)). Such a sampled latent representation 205 is then decoded by a decoder 206 in an attempt to reconstruct the input (x) 202 received by encoder 201 based on the sampled latent representation 205. Such an output of decoder 206 is said to correspond to the input reconstruction (d(z)) 207.

In essence, encoder 201 performs dimensionality reduction by compressing the data (from the initial space to the encoded space or latent space); whereas, decoder 206 decompresses the compressed data.

In one embodiment, variational autoencoder 200 assumes that the latent variables are Gaussian. In one embodiment, the objective of variational autoencoder 200 is to learn an encoder 201 that is able to provide the mean and variance of the hidden variables for each data point and a decoder 206 that is able to reconstruct the corresponding observation in the input space. In one embodiment, both encoder 201 and decoder 206 are trained with the empirical lower bound objective that aims to improve the accuracy of variational autoencoder 200 by maximizing the empirical lower bound objective. A more detailed description of these and other features is provided below

Returning to FIG. 1, by utilizing a trained variational autoencoder 200 discussed above, in-distribution sample generator 101 is able to generate in-distribution neighborhood samples of an instance of a dataset (e.g., time-series data, image data) in latent space that satisfies a distortion constraint. Furthermore, by utilizing the trained variational autoencoder 200 discussed above, in-distribution sample generator 101 generates a set of interpretable examples for the in-distribution neighborhood samples using a k-nearest neighbors algorithm in order to explain the black box model's predictions. These and other features will be discussed in further detail below.

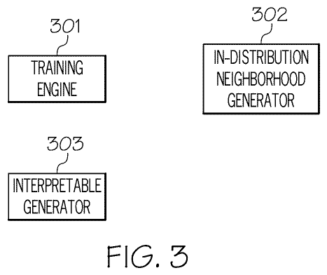

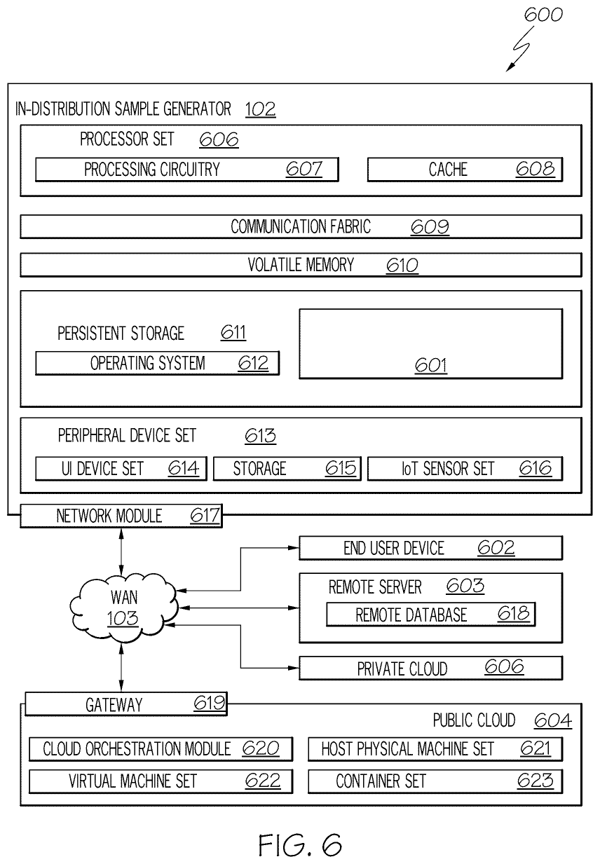

Furthermore, a description of the software components of in-distribution sample generator 101 is provided below in connection with FIG. 3 and a description of the hardware configuration of in-distribution sample generator 101 is provided further below in connection with FIG. 6.

System 100 is not to be limited in scope to any one particular network architecture. System 100 may include any number of in-distribution sample generators 101, computing devices 102 and networks 103.

A discussion regarding the software components used by in-distribution sample generator 101 to generate in-distribution samples of data 104 for a neighborhood distribution to be used by post-hoc local explanation methods is provided below in connection with FIG. 3.

FIG. 3 is a diagram of the software components of in-distribution sample generator 101 used to generate in-distribution samples of data 104 for a neighborhood distribution to be used by post-hoc local explanation methods in accordance with an embodiment of the present disclosure.

Referring to FIG. 3, in conjunction with FIGS. 1-2, in-distribution sample generator 101 includes a training engine 301 configured to train variational autoencoder 200 to generate in-distribution neighborhood samples of an instance of a dataset (e.g., time-series data, image data) in the latent space that satisfies a distortion constraint.

In one embodiment, training engine 301 trains variational autoencoder 200 to generate in-distribution neighborhood samples of an instance of a dataset (e.g., time-series data, image data) in the latent space that satisfies a distortion constraint by encoding an input (e.g., input (x) 202) by encoder 201 as a distribution over a latent space, where input (x) 202 corresponds to an instance of the dataset. An instance of a dataset, as used herein, refers to an observation from the domain (i.e., the dataset). A “distortion constraint,” as used herein, refers to the minimum amount of distortion between the instance and the obtained neighborhood sample.

After encoding the input as a distribution over the latent space, a point of distribution from the latent space may then be sampled, such as by sampler 204. In one embodiment, the point of distribution from the latent space is sampled using a reparameterization trick

Z−=(μ_{ϕ}+(x)+θσ_{ϕ}(x),η˜N(0,I)

where μ_{ϕ}(x) and σ_{ϕ}(x) are the outputs of encoder 201.

In one embodiment, the sampled point is then decoded by decoder 206 which corresponds to an input reconstruction, such as input reconstruction 207 (\hat{x}=g_{θ}(z)) where the input reconstruction satisfies a minimum distortion level. The “input reconstruction 207,” as used herein, refers to an estimate of the input, such as input (x) 202. In one embodiment, the maximum distortion level or a maximum distortion objective (ε) is provided by an expert, such as a user of computing device 102.

In one embodiment, given an instance x and a maximum distortion objective ε, a neighborhood sample [symbol] is obtained by perturbing the latent Gaussian variable η in such a way that reconstruction signal 207 satisfies a maximum distortion level with probability at least δ: p(Δ( [symbol] )≤ϵ)≥δ.

In one embodiment, after decoding the sampled point which corresponds to an input reconstruction, such as input reconstruction 207, a reconstruction error is computed. Such a reconstruction error corresponds to the measured difference between the input reconstruction, such as input reconstruction 207, and the original input, such as input (x) 202. In one embodiment, such a measured difference corresponds to the Euclidean distance, Manhattan distance, Minkowski distance, Hamming distance, etc.

In one embodiment, variational autoencoder 200 is trained to minimize such a reconstruction error. In one embodiment, the reconstruction error is backpropagated through the network and the above-process continues to be repeated until the reconstruction error is less than a user-designated threshold value.

In one embodiment, variational autoencoder 200 is trained to minimize the loss function that is composed of input reconstruction 207 (on the final layer) and a regularization term (on the latent layer) that tends to regularize the organization of the latent space by making the distributions returned by encoder 201 close to a standard normal distribution. In one embodiment, the regularization term is expressed as the Kulback-Leibler divergence between input reconstruction 207 and a standard Gaussian. In one embodiment, the Kulback-Leibler divergence between two Gaussian distributions has a closed form that is directly expressed in terms of the means and the covariance matrices of the two distributions.

In one embodiment, training engine 301 utilizes various software tools for training variational autoencoder 200, including, but not limited to, Keras®, DeepPy, neon, PyTorch®, JAX, TensorFlow®, etc.

After training variational autoencoder 200 by training engine 301, in-distribution neighborhood generator 302 of in-distribution sample generator 101 is configured to utilize the trained variational autoencoder to generate in-distribution neighborhood samples of an instance of a dataset in the latent space that satisfies a distortion constraint. As discussed above, an instance of a dataset, as used herein, refers to an observation from the domain (i.e., the dataset). As further discussed above, the “distortion constraint,” as used herein, refers to the minimum amount of distortion between the instance and the obtained neighborhood sample.

In one embodiment, a description of neighborhood generation with variational autoencoder 200 is discussed below.

In one embodiment, variational autoencoder (VAE) 200 is trained to maximize the evidence lower bound (ELBO) with a given dataset (this a standard optimization objective for the VAE).

As discussed herein, z represents the latent code variable and x represents the input space variable.

In one embodiment, the Gaussian VAE setting is considered, where the distribution of the latent codes is assumed to be gaussian z˜p(z)= [symbol] (0,I), and the conditional distribution of the latent code for a given instance x is q_{ϕ}(z|x)= [symbol] (μ_{φ}(x), diag(σ_{φ}(x))) with μ_{φ}(x), σ_{φ}(x) the median and variance of the distribution. μ_{φ}(x), σ_{φ}(x) are the outputs of encoder 201, parametrized by ¢, that takes as an input a given instance x in the input space. In one embodiment, the reconstruction is obtained with decoder 206 g_{θ}(z)≃ [symbol] ₚ_{_{θ}}_{(x|z)}[x], parametrized by θ, that takes a latent code variable z as an input 202. In one embodiment, decoder 206 is approximating the expected reconstruction under distribution p_{\theta}(x|z), such as a Gaussian distribution since an L2 reconstruction loss is considered in the ELBO.

In one embodiment, in order to generate the neighborhood, in addition to the trained VAE 200, the following is utilized: an instance \hat{x}, to center the neighborhood and a lower bound, \gamma, for the likelihood of the latent codes of the neighborhood. This is the in-distribution constraint which is denoted as φ(z)≥γ, where φ(·) denotes the likelihood of a standard gaussian distribution (assumed on the latent space). Furthermore, in order to generate the neighborhood, the following is utilized: a probability coverage condition on the distance/distortion with respect to the median reconstruction of \hat{x}. In one embodiment, the probability coverage condition is expressed as p(∥g_{θ}(z)−g_{θ}(μ_{φ}(\hat{x}))∥₂²≤ϵ)≥δ, where g(z) represents a reconstructed neighbor, and g(μ(\hat{x}))) is the median reconstruction of \hat{x}. In one embodiment, epsilon and delta are provided by the user. This condition implies that the probability of the distance of the neighborhoods with respect to the median reconstruction of \hat{x} being smaller than epsilon, which is larger than delta.

In one embodiment, a neighborhood is generated that satisfies the in-distribution and probabilistic distance condition in the following way: (1) sample the directions of the neighbors in the latent space from the unit-sphere:

$$\frac{η}{{‖ η ‖}_{2}} , η ∼ 𝒩 ( 0 , I ) ;$$

(2) for each direction, a truncated chi2 distribution is defined from the module

$$r ( η ) ∼ {𝒳}_{ds} \vert r \leq \frac{{r}_{δ}}{\sqrt{ϵ}} {r}_{γ}^{u} ( η )$$

which is sampled for the directions in the instance \hat{x}. In one embodiment, the truncation parameter

$$\frac{{r}_{δ}}{\sqrt{ϵ}} {r}_{γ}^{u} ( η )$$

of the chi2 distribution depends on the in-distribution and distance constraints, and requires the computation of two terms: (1) r_{δ}, which is an empirical approximation of the δ-quantile of the reconstruction error: p_{z˜q}_{_{φ}}_{(z|\hat{x})}(∥g_{θ}(z)−g_{θ}(μ_{φ}(\hat{x}))∥₂²≤r_{δ}²)=δ; (2) r_{γ}^{u}(η) which is a maximum admissible module based on the in-distribution constraint

$${r}_{γ}^{u} ( η ) = {‖ η ‖}_{2} \frac{\begin{matrix}- {μ}_{ϕ}^{T} ( \dot{x} ) ( {ηoσ}_{ϕ} ( \dot{x} ) ) + \\ \sqrt{{( {μ}_{ϕ}^{T} ( \dot{x} ) ( {ηoσ}_{ϕ} ( \dot{x} ) ) )}^{2} - {‖ {ηoσ}_{ϕ} ( \dot{x} ) ‖}_{2}^{2} ( {‖ {μ}_{ϕ} ( \hat{x} ) ‖}_{2}^{2} + {d}_{z} ln ( 2 π ) + 2 ln γ )}\end{matrix}}{{‖ {ηoσ}_{ϕ} ( \hat{x} ) ‖}_{2}^{2}} .$$

In one embodiment, the generated neighbor in the latent space is obtained by computing:

$$z = {μ}_{ϕ} ( \hat{x} ) + \frac{\sqrt{ϵ}}{{r}_{δ}} r ( η ) ( \frac{η}{{‖ η ‖}_{2}} o {σ}_{ϕ} ( \hat{x} ) ) with r ( η ) ∼ {𝒳}_{{d}_{z} \vert r \leq \frac{{r}_{δ}}{\sqrt{ϵ}} {r}_{γ}^{u} ( η ) .}$$

As a result, the reconstructed neighbor is g_{θ}(z)).

The procedure described above generates a neighborhood that satisfies the likelihood constraint and the distance constraint with an approximation error.

In one embodiment, in-distribution neighborhood generator 302 utilizes the trained variational autoencoder 200 to encode an instance, such as instance x 202, of the dataset (e.g., time-series data, image data) by encoder 201.

In one embodiment, the encoded instance corresponds to a Gaussian distribution in the latent space. In such an embodiment, after encoding the instance of the dataset, a mean and a standard deviation of the encoded instance is computed by in-distribution neighborhood generator 302. Various software tools may be utilized by in-distribution neighborhood generator 302 to compute the mean and standard deviation of the encoded instance, including, but not limited to, Vose, Minitab®, MathWorks®, SigmaXL, etc.

After computing the mean and standard deviation of the encoded instance, in-distribution neighborhood generator 302 samples a set of latent vectors (or latent variables) from the Gaussian distribution in the latent space with the mean and standard deviation of the encoded instance. “Latent vectors” or “latent variables,” as used herein, refer to variables that can only be inferred indirectly from other observable variables that can be directly observed or measured. In one embodiment, such sampling involves sampling η₀˜(0,I).

In one embodiment, in-distribution neighborhood generator 302 receives a lower bound for the latent space of the in-distribution neighborhood samples, such as from an expert (e.g., user of computing device 102). In one embodiment, the lower bound corresponds to the lower bound on the loglikelihood to maximize, where l(θ) is the loglikelihood function:

l(θ):=log p(x;θ)=log ∫_{z}p(x,z;θ)dz

In one embodiment, in-distribution neighborhood generator 302 estimates the percentiles of a Gaussian variational autoencoder distortion distribution to compute an upper bound for the latent space of the in-distribution neighborhood samples. The “variational autoencoder distortion,” as used herein, refers to the difference between data points (latent variables) in the latent space and the input data, such as input (x) 202. In one embodiment, the latent variables are Gaussian and hence the variational autoencoder distortion distribution corresponds to a Gaussian distortion. In one embodiment, the median of a distribution corresponds to the value in the middle of the distribution. In one embodiment, the upper bound for the latent space of the in-distribution neighborhood samples corresponds to a user-designated amount or percentage above the median of the distribution. In one embodiment, such a user-designated amount or percentage is provided by an expert, such as a user of computing device 102.

In one embodiment, the lower and upper bounds for the latent space of the in-distribution neighborhood samples are utilized to ensure that the in-distribution samples of the instance of the dataset in latent space are in-distribution and satisfy the distortion constraint.

In one embodiment, in-distribution neighborhood generator 302 normalizes the set of latent vectors. “Normalizing,” as used herein, refers to changing the values of the latent vectors to a common scale without distorting the differences in the range of values. In one embodiment, such normalization is the I2 normalization, such that the Frobenius norm of the latent vectors is 1. In one embodiment, in-distribution neighborhood generator 302 utilizes various software tools for normalizing the set of latent vectors, including, but not limited to, Flexera® One, Normalyzer, etc.

In one embodiment, in-distribution neighborhood generator 302 samples the norm of the latent vectors from a truncated chi-square distribution. The truncated coefficient is designed to satisfy the distortion and in-distribution constraints.

The “chi-square distribution,” as used herein, refers to the distribution of a sum of the square of k normalized latent vectors. The “truncated chi-square distribution,” as used herein, refers to performing the chi-square distribution on a truncated distribution of the normalized latent vectors.

In one embodiment, in-distribution neighborhood generator 302 utilizes various software tools for resampling the normalized latent vectors according to a chi-square distribution (or a truncated chi-square distribution) using the lower bound and the upper bound for the latent space, including, but not limited to, SPSS® Statistics, JMP®, JASP, etc.

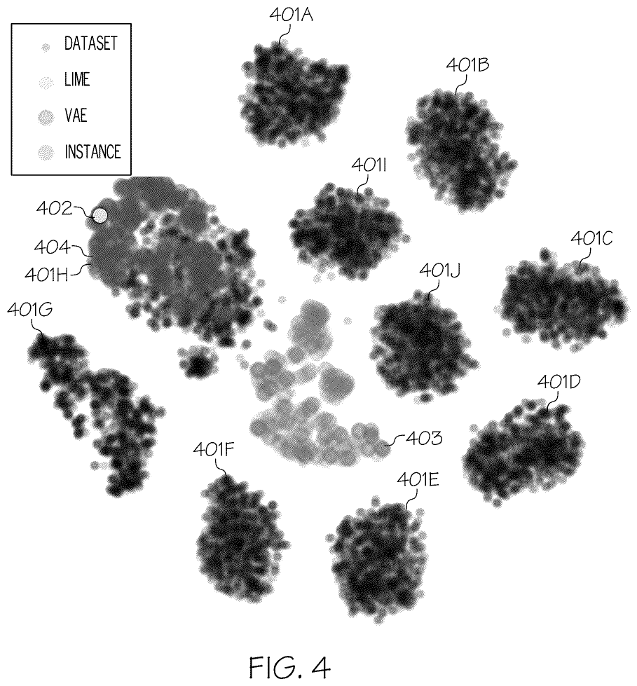

An example of the generated in-distribution neighborhood samples of the instance of the dataset is shown in FIG. 4.

Referring to FIG. 4, FIG. 4 illustrates the in-distribution neighborhood samples of the instance of the dataset in accordance with an embodiment of the present disclosure.

As shown in FIG. 4, the latent representations of the dataset are represented in clusters 401A-401J. Clusters 401A-401J may collectively or individually be referred to as clusters 401 or cluster 401, respectively. The local instance to be explained is illustrated in element 402.

As also shown in FIG. 4, the embedding of the LIME neighborhood (see element 403) is outside of the normal dataset representations (out of distribution) and far from the representation of the explained instance. However, the representation of the variational autoencoder neighborhood generated by the trained variational autoencoder 200 (see element 404) is close to the explained instance and is also in-distribution (overlaps with the dataset embedding).

In addition, to localizing the perturbation and controlling the distortion, the principles of the present disclosure are utilized to generate a set of representative in-distribution examples using a k-nearest neighbors algorithm in order to explain the black box model's predictions as discussed below.

Returning to FIG. 3, in conjunction with FIGS. 1-2, in-distribution sample generator 101 includes interpretable generator 303 configured to generate a set of representative in-distribution examples using a k-nearest neighbors algorithm. In one embodiment, given an in-distribution neighborhood (n( [symbol] | [symbol] )), interpretable generator 303 generates a set of interpretable examples that are closest to the original instance, \hat{x}. In one embodiment, interpretable generator 303 picks the closest k examples that are identified using the k-nearest neighbors algorithm as discussed further below.

In one embodiment, interpretable generator 303 samples a set of representative examples from the generated in-distribution samples in the latent space that belongs to a class, c. For instance, for each class c, a set of representative examples R in the latent space that belong to class c is sampled. In one embodiment, such sampling corresponds to randomly sampling representative examples in the generated in-distribution samples in the latent space that belongs to class c. In one embodiment, such sampling is based on criteria established by an expert, such as possessing particular features (e.g., points, lines, edges, objects, areas). A “class,” as used herein, refers to the label or category which provides context.

In one embodiment, interpretable generator 303 computes a set of k-nearest neighbors to the input, such as input (x) 202, in the latent space with respect to the set of representative examples. In one embodiment, input (x) 202 corresponds to an instance of the dataset in the latent space. In one embodiment, interpretable generator 303 computes the set of k-nearest neighbors in the set of representative examples with respect to the input, such as input (x) 202, in the latent space using the k-nearest neighbors algorithm.

In one embodiment, interpretable generator 303 determines the distance between the input, such as input (x) 202, and the other data points in the latent space (i.e., the set of representative samples). In one embodiment, interpretable generator 303 performs one of the following distance measures, such as the Euclidean distance, Manhattan distance, Minkowski distance, Hamming distance, etc., to obtain the distance between the input, such as input (x) 202, and the other data points in the latent space (i.e., the set of representative samples). In one embodiment, interpretable generator 303 implements the k-nearest neighbors algorithm using such distance calculations to identify the set of k-nearest neighbors to the input, such as input (x) 202, in the latent space. In one embodiment, interpretable generator 303 utilizes various software tools for implementing the k-nearest neighbors algorithm, including, but not limited to, MathWorks®, Cognos® Analytics, Netezza®, Planning Analytics, SPSS®, etc.

In one embodiment, interpretable generator 303 generates a set of interpretable (explanation) examples for in-distribution neighborhood samples corresponding to the k-nearest neighbors.

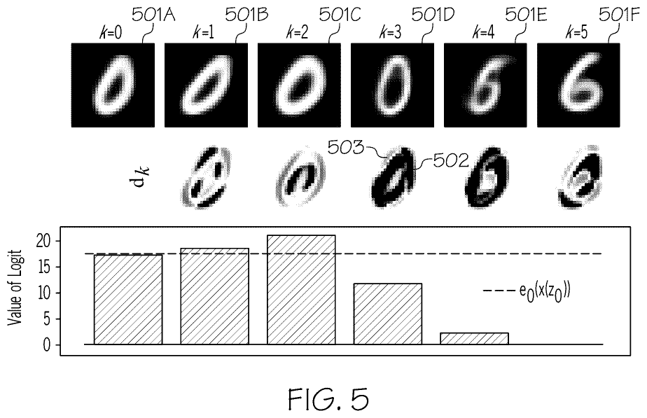

An illustration of generating a set of interpretable (explanation) examples for the in-distribution neighborhood samples using a k-nearest neighbors algorithm is shown in FIG. 5.

FIG. 5 illustrates a representative example-based explanation for a 10-digit classifier in accordance with an embodiment of the present disclosure.

As shown in FIG. 5, there are six explanation examples 501A-501F (corresponding to k=0 to k=5), where k=0 is the instance that is to be explained locally. Explanation examples 501A-501F may collectively or individually be referred to as explanation examples 501 or explanation example 501, respectively. In one embodiment, such explanation examples 501 are generated using the process discussed above.

FIG. 5 further illustrates the different spatial perturbation maps that the local instance presents in the in-distribution neighborhood (502 indicates a negative difference while 503 indicates a positive difference) to highlight the difference (dₖ) with respect to the local instance.

Furthermore, FIG. 5 illustrates the output of a classifier for the logit of digit 0 on each of the explanation examples. For examples k=1 and k=2, the value of the logit increases with respect to the local instance (k=0). However, for examples k=3, 4 and 5, the value of the logit decreases considerably. It is noted that k=3 visually corresponds to a 0 digit, but is thinner than the other 0 digit examples (k=0, 1 and 2) indicating that the classifier seems to decrease its prediction score if the 0-digit is thinner.

A further description of these and other functions is provided below in connection with the discussion of the method for generating low-distortion, in-distribution neighborhood samples of an instance of a dataset (e.g., time-series data, image data) using a variational autoencoder as well as generating a set of representative in-distribution examples for the in-distribution neighborhood samples.

Prior to the discussion of the method for generating low-distortion, in-distribution neighborhood samples of an instance of a dataset (e.g., time-series data, image data) using a variational autoencoder as well as generating a set of representative in-distribution examples for the in-distribution neighborhood sample, a description of the hardware configuration of in-distribution sample generator 101 (FIG. 1) is provided below in connection with FIG. 6.

Referring now to FIG. 6, in conjunction with FIG. 1, FIG. 6 illustrates an embodiment of the present disclosure of the hardware configuration of in-distribution sample generator 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as generating low-distortion, in-distribution neighborhood samples of an instance of a dataset (e.g., time-series data, image data) using a variational autoencoder as well as generating a set of representative in-distribution examples for the in-distribution neighborhood sample. In addition to block 601, computing environment 600 includes, for example, in-distribution sample generator 101, network 103, such as a wide area network (WAN), end user device (EUD) 602, remote server 603, public cloud 604, and private cloud 605. In this embodiment, in-distribution sample generator 101 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

In-distribution sample generator 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically in-distribution sample generator 101, to keep the presentation as simple as possible. In-distribution sample generator 101 may be located in a cloud, even though it is not shown in a cloud in FIG. 6. On the other hand, in-distribution sample generator 101 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto in-distribution sample generator 101 to cause a series of operational steps to be performed by processor set 606 of in-distribution sample generator 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of in-distribution sample generator 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In in-distribution sample generator 101, the volatile memory 610 is located in a single package and is internal to in-distribution sample generator 101, but, alternatively or additionally, the volatile memory may be distributed over multiple packages and/or located externally with respect to in-distribution sample generator 101.

Persistent Storage 611 is any form of non-volatile storage for computers that is now known or to be developed in the future. The non-volatility of this storage means that the stored data is maintained regardless of whether power is being supplied to in-distribution sample generator 101 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of in-distribution sample generator 101. Data communication connections between the peripheral devices and the other components of in-distribution sample generator 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where in-distribution sample generator 101 is required to have a large amount of storage (for example, where in-distribution sample generator 101 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows in-distribution sample generator 101 to communicate with other computers through WAN 103. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to in-distribution sample generator 101 from an external computer or external storage device through a network adapter card or network interface included in network module 617.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates in-distribution sample generator 101), and may take any of the forms discussed above in connection with in-distribution sample generator 101. EUD 602 typically receives helpful and useful data from the operations of in-distribution sample generator 101. For example, in a hypothetical case where in-distribution sample generator 101 is designed to provide a recommendation to an end user, this recommendation would typically be communicated from network module 617 of in-distribution sample generator 101 through WAN 103 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to in-distribution sample generator 101. Remote server 603 may be controlled and used by the same entity that operates in-distribution sample generator 101. Remote server 603 represents the machine(s) that collect and store helpful and useful data for use by other computers, such as in-distribution sample generator 101. For example, in a hypothetical case where in-distribution sample generator 101 is designed and programmed to provide a recommendation based on historical data, then this historical data may be provided to in-distribution sample generator 101 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to generate low-distortion, in-distribution neighborhood samples of an instance of a dataset (e.g., time-series data, image data) using a variational autoencoder as well as to generate a set of representative in-distribution examples for the in-distribution neighborhood samples. In one embodiment, such components may be implemented in hardware. The functions discussed above performed by such components are not generic computer functions. As a result, in-distribution sample generator 101 is a particular machine that is the result of implementing specific, non-generic computer functions.

In one embodiment, the functionality of such software components of in-distribution sample generator 101, including the functionality for generating low-distortion, in-distribution neighborhood samples of an instance of a dataset (e.g., time-series data, image data) using a variational autoencoder as well as generating a set of representative in-distribution examples for the in-distribution neighborhood samples may be embodied in an application specific integrated circuit.

As stated above, an example of a post-hoc local explanation method is the local interpretable model-agnostic explanation (LIME) method. LIME is a method that fits a surrogate glassbox model around the decision space of any black box model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the black box model behaves in that region. LIME works by perturbing any individual datapoint (perturbations correspond to small changes in the system, such as small changes in the gradients, weights, inputs. etc.) and generating synthetic data which gets evaluated by the black box system, and ultimately used as a training set for the glassbox model. LIME's advantages are that you can interpret an explanation the same way you reason about a linear model, and that it can be used on almost any model. Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method. Furthermore, while such neighborhood distributions are inherently interpretable, the explanations generated may not capture the correlated behaviors of the model. As a result, the correlations between the features (e.g., features created from a time stamp value of an observation) of a neighborhood distribution may not be effectively captured. Additionally, by not effectively capturing the correlations between the features of the neighborhood distribution, a set of interpretable examples for the in-distribution neighborhood samples cannot be generated in order to explain the black box model's predictions. Unfortunately, there is not currently a means for generating in-distribution samples of a dataset, such as time-series or image data, for the neighborhood distribution to be used by the post-hoc local explanation methods. Furthermore, there is not currently a means for effectively capturing the correlations between the features of the neighborhood distribution or effectively generating a set of representative in-distribution examples in order to explain the black box model's predictions. By generating such in-distribution samples of a dataset, such as time-series or image data, for the neighborhood distribution as well as capturing the correlations between the features of the neighborhood distribution and generating a set of representative in-distribution examples, the accuracy of the decision making ability of the post-hoc local explanation method is improved.

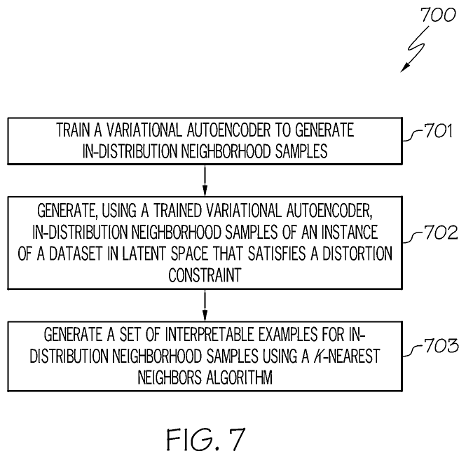

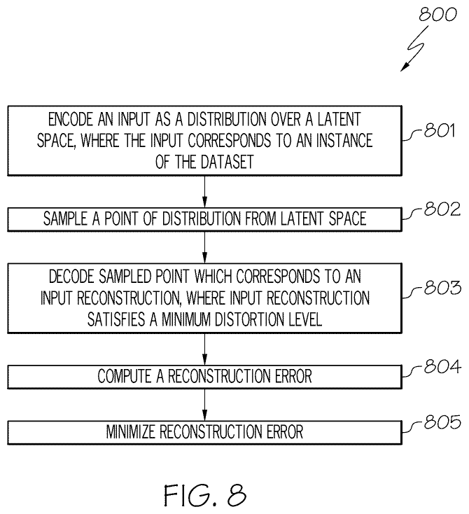

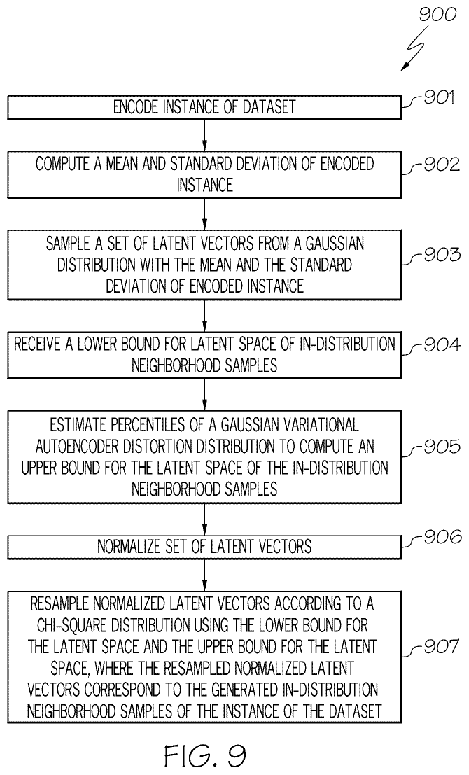

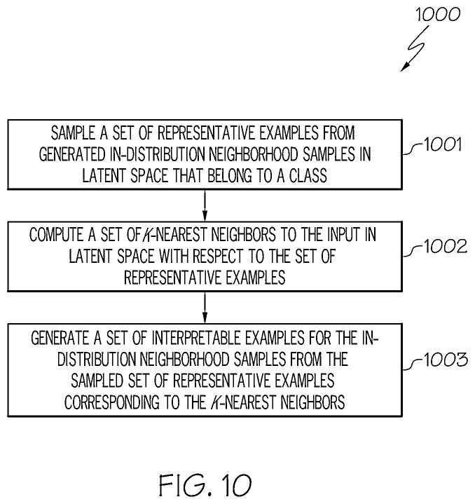

The embodiments of the present disclosure provide a means for generating low-distortion, in-distribution neighborhood samples of an instance of a dataset (e.g., time-series data, image data) by utilizing a variational autoencoder. Furthermore, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of post-hoc local explanation methods is improved. These and other features will be discussed in further detail below in connection with FIGS. 7-10. FIG. 7 is a flowchart of a method for utilizing a variational autoencoder for neighborhood sampling. FIG. 8 is a flowchart of a method for training the variational autoencoder to generate in-distribution neighborhood samples of an instance of a dataset in latent space that satisfies a distortion constraint. FIG. 9 is a flowchart of a method for generating local neighborhoods that satisfy a distortion constraint. FIG. 10 is a flowchart of a method for generating a set of representative in-distribution examples.

As stated above, FIG. 7 is a flowchart of a method 700 for utilizing a variational autoencoder for neighborhood sampling in accordance with an embodiment of the present disclosure.

Referring to FIG. 7, in conjunction with FIGS. 1-6, in step 701, training engine 301 of in-distribution sample generator 101 trains a variational autoencoder 200 to generate in-distribution neighborhood samples.

A discussion regarding training a variational autoencoder, such as variational autoencoder 200, to generate in-distribution neighborhood samples is discussed below in connection with FIG. 8.

FIG. 8 is a flowchart of a method 800 for training the variational autoencoder to generate in-distribution neighborhood samples of an instance of a dataset in latent space that satisfies a distortion constraint in accordance with an embodiment of the present disclosure.

Referring to FIG. 8, in conjunction with FIGS. 1-7, in step 801, training engine 301 of in-distribution sample generator 101 encodes an input, such as input (x) 202, as a distribution over a latent space that satisfies a distortion constraint, where the input corresponds to an instance of the dataset (e.g., time-series data, image data). In one embodiment, training engine 301 utilizes encoder 201 to encode the input, such as input (x) 202, as a distribution over the latent space.

As discussed above, an instance of a dataset, as used herein, refers to an observation from the domain (i.e., the dataset). A “distortion constraint,” as used herein, refers to the minimum amount of distortion between the instance and the obtained neighborhood sample.

In step 802, training engine 301 of in-distribution sample generator 101 samples a point of distribution from the latent space using sampler 204.

As stated above, after encoding the input, such as input (x) 202, as a distribution over the latent space, a point of distribution from the latent space may then be sampled, such as by sampler 204. In one embodiment, the point of distribution from the latent space is sampled using a reparameterization trick

Z−=(μ_{ϕ}+(x)+θσ_{ϕ}(x),η˜N(0,I)

where μ_{ϕ}(x) and σ_{ϕ}(x) are the outputs of encoder 201.

In step 803, training engine 301 of in-distribution sample generator 101 decodes the sampled point which corresponds to an input reconstruction using decoder 206, where the input reconstruction satisfies a minimum distortion level.

As discussed above, in one embodiment, the sampled point is then decoded by decoder 206 which corresponds to an input reconstruction, such as input reconstruction 207 (\hat{x}=g_{θ}(z)) where the input reconstruction satisfies a minimum distortion level. The “input reconstruction 207,” as used herein, refers to an estimate of the input, such as input (x) 202. In one embodiment, the maximum distortion level or a maximum distortion objective (ε) is provided by an expert, such as a user of computing device 102.

In one embodiment, given an instance x and a maximum distortion objective ε, a neighborhood sample [symbol] is obtained by perturbing the latent Gaussian variable η in such a way that reconstruction signal 207 satisfies a maximum distortion level with probability at least δ: p(Δ( [symbol] )≤ϵ)≥δ.

In step 804, training engine 301 of in-distribution sample generator 101 computes a reconstruction error.

As stated above, in one embodiment, such a reconstruction error corresponds to the measured difference between the input reconstruction, such as input reconstruction 207, and the original input, such as input (x) 202. In one embodiment, such a measured difference corresponds to the Euclidean distance, Manhattan distance, Minkowski distance, Hamming distance, etc.

In step 805, training engine 301 of in-distribution sample generator 101 trains variational autoencoder 200 to minimize the reconstruction error. In one embodiment, the reconstruction error is backpropagated through the network and the above-process continues to be repeated until the reconstruction error is less than a user-designated threshold value.

As discussed above, in one embodiment, variational autoencoder 200 is trained to minimize the loss function that is composed of input reconstruction 207 (on the final layer) and a regularization term (on the latent layer) that tends to regularize the organization of the latent space by making the distributions returned by encoder 201 close to a standard normal distribution. In one embodiment, the regularization term is expressed as the Kulback-Leibler divergence between input reconstruction 207 and a standard Gaussian. In one embodiment, the Kulback-Leibler divergence between two Gaussian distributions has a closed form that is directly expressed in terms of the means and the covariance matrices of the two distributions.

In one embodiment, training engine 301 utilizes various software tools for training variational autoencoder 200, including, but not limited to, Keras®, DeepPy, neon, PyTorch®, JAX, TensorFlow®, etc.

Returning to FIG. 7, in conjunction with FIGS. 1-8, in step 702, in-distribution neighborhood generator 302 of in-distribution sample generator 101 generates, using the trained variational autoencoder 200 as discussed above, in-distribution neighborhood samples of an instance of a dataset in the latent space that satisfies a distortion constraint.

As discussed above, an instance of a dataset, as used herein, refers to an observation from the domain (i.e., the dataset). As further discussed above, the “distortion constraint,” as used herein, refers to the minimum amount of distortion between the instance and the obtained neighborhood sample.

In one embodiment, a description of neighborhood generation with a variational autoencoder 200 is discussed below.

In one embodiment, variational autoencoder (VAE) 200 is trained to maximize the evidence lower bound (ELBO) with a given dataset (this a standard optimization objective for the VAE).

As discussed herein, z represents the latent code variable and x represents the input space variable.

In one embodiment, the Gaussian VAE setting is considered, where the distribution of the latent codes is assumed to be gaussian z˜p(z)= [symbol] (0,I), and the conditional distribution of the latent code for a given instance x is q_{ϕ}(z|x)= [symbol] (μ_{ϕ}(x), diag(σ_{φ}(x))) with μ_{ϕ}(x), σ_{ϕ}(x) the median and variance of the distribution. μ_{ϕ}(x), σ_{ϕ}(x) are the outputs of encoder 201, parametrized by ϕ, that takes as an input a given instance x in the input space. In one embodiment, the reconstruction is obtained with decoder 206 g_{θ}(z)≃ [symbol] ₚ_{_{θ}}_{(x|z)}[x], parametrized by θ, that takes a latent code variable z as an input 202. In one embodiment, decoder 206 is approximating the expected reconstruction under distribution p_{\theta}(x|z), such as a Gaussian distribution since an L2 reconstruction loss is considered in the ELBO.

In one embodiment, in order to generate the neighborhood, in addition to the trained VAE 200, the following is utilized: an instance \hat{x}, to center the neighborhood and a lower bound, \gamma, for the likelihood of the latent codes of the neighborhood. This is the in-distribution constraint which is denoted as φ(z)≥γ, where φ(·) denotes the likelihood of a standard gaussian distribution (assumed on the latent space). Furthermore, in order to generate the neighborhood, the following is utilized: a probability coverage condition on the distance/distortion with respect to the median reconstruction of \hat{x}. In one embodiment, the probability coverage condition is expressed as p(∥g_{θ}(z)−g_{θ}(μ_{φ}(\hat{x}))∥₂²≤ϵ)≥δ, where g(z) represents a reconstructed neighbor, and g(μ(\hat{x}))) is the median reconstruction of \hat{x}. In one embodiment, epsilon and delta are provided by the user. This condition implies that the probability of the distance of the neighborhoods with respect to the median reconstruction of \hat{x} being smaller than epsilon, which is larger than delta.

In one embodiment, a neighborhood is generated that satisfies the in-distribution and probabilistic distance condition in the following way: (1) sample the directions of the neighbors in the latent space from the unit-sphere:

$$\frac{η}{{‖ η ‖}_{2}} , η ∼ 𝒩 ( 0 , I ) ;$$

(2) for each direction, a truncated chi2 distribution is defined from the module

$$r ( η ) ∼ {𝒳}_{{d}_{z} \vert r \leq \frac{{r}_{δ}}{\sqrt{ϵ}} {r}_{γ}^{u}} ( η )$$

which is sampled for the directions in the instance \hat{x}. In one embodiment, the truncation parameter

$${\frac{{r}_{δ}}{\sqrt{ϵ}} {r}_{γ}^{u}}_{} ( η )$$

of the chi2 distribution depends on the in-distribution and distance constraints, and requires the computation of two terms: (1) r_{δ}, which is an empirical approximation of the δ-quantile of the reconstruction error: p_{z˜q}_{_{φ}}_{(z|\hat{x})}(∥g_{θ}(z)−g_{θ}(μ_{φ}(\hat{x}))∥₂²≤r_{δ}²)=δ; (2) r_{γ}^{u}(η) which is a maximum admissible module based on the in-distribution constraint

$${r}_{γ}^{u} ( η ) = {‖ η ‖}_{2} \frac{\begin{matrix}- {μ}_{ϕ}^{T} ( \dot{x} ) ( {ηoσ}_{ϕ} ( \dot{x} ) ) + \\ \sqrt{{( {μ}_{ϕ}^{T} ( \dot{x} ) ( {ηoσ}_{ϕ} ( \dot{x} ) ) )}^{2} - {‖ {ηoσ}_{ϕ} ( \dot{x} ) ‖}_{2}^{2} ( {‖ {μ}_{ϕ} ( \hat{x} ) ‖}_{2}^{2} + {d}_{z} ln ( 2 π ) + 2 ln γ )}\end{matrix}}{{‖ {ηoσ}_{ϕ} ( \hat{x} ) ‖}_{2}^{2}} .$$

In one embodiment, the generated neighbor in the latent space is obtained by computing:

$$z = {μ}_{ϕ} ( \hat{x} ) + \frac{\sqrt{ϵ}}{{r}_{δ}} r ( η ) ( \frac{η}{{‖ η ‖}_{2}} o {σ}_{ϕ} ( \hat{x} ) ) with r ( η ) ∼ {𝒳}_{{d}_{z} \vert r \leq \frac{{r}_{δ}}{\sqrt{ϵ}} {r}_{γ}^{u} ( η ) .}$$

As a result, the reconstructed neighbor is g_{θ}(z)).

The procedure described above generates a neighborhood that satisfies the likelihood constraint and the distance constraint with an approximation error.

In one embodiment, such an objective is solved with the penalty method (replaces a constrained optimization problem by a series of unconstrained problems whose solutions ideally converge to the solution of the original constrained problem). In one embodiment, the unconstrained problems are formed by adding a term, called a penalty function, to the objective function that consists of a penalty parameter multiplied by a measure of violation of the constraints. The measure of violation is nonzero when the constraints are violated and is zero in the region where constraints are not violated. In one embodiment, in order to minimize the number of iterations, the iterations stop when the constraints are satisfied and ∥η∥≤θ₀∥nll ≤ Ilnoll.

A more detailed discussion regarding generating, using the trained variational autoencoder 200, in-distribution neighborhood samples of an instance of a dataset in the latent space that satisfies a distortion constraint is provided below in connection with FIG. 9.

FIG. 9 is a flowchart of a method 900 for generating local neighborhoods that satisfy a distortion constraint in accordance with an embodiment of the present disclosure.

Referring to FIG. 9, in conjunction with FIGS. 1-8, in step 901, in-distribution neighborhood generator 302 of in-distribution sample generator 101 utilizes the trained variational autoencoder 200 to encode an instance, such as instance (x) 202, of the dataset (e.g., time-series data, image data) by encoder 201.

As discussed above, in one embodiment, the input to the trained variational autoencoder 200 includes the instance (x) 202.

In step 902, in-distribution neighborhood generator 302 of in-distribution sample generator 101 computes a mean and a standard deviation of the encoded instance.

As stated above, in one embodiment, the encoded instance corresponds to a Gaussian distribution in the latent space. In such an embodiment, after encoding the instance of the dataset, a mean and a standard deviation of the encoded instance is computed by in-distribution neighborhood generator 302. Various software tools may be utilized by in-distribution neighborhood generator 302 to compute the mean and standard deviation of the encoded instance, including, but not limited to, Vose, Minitab®, MathWorks®, SigmaXL, etc.

After computing the mean and standard deviation of the encoded instance, in step 903, in-distribution neighborhood generator 302 of in-distribution sample generator 101 samples a set of latent vectors (or latent variables) from the Gaussian distribution in the latent space with the mean and standard deviation of the encoded instance.

As discussed above, “latent vectors” or “latent variables,” as used herein, refer to variables that can only be inferred indirectly from other observable variables that can be directly observed or measured. In one embodiment, such sampling involves sampling η₀˜N(0,I).

In step 904, in-distribution neighborhood generator 302 of in-distribution sample generator 101 receives a lower bound for the latent space of the in-distribution neighborhood samples, such as from an expert (e.g., user of computing device 102).

As stated above, in one embodiment, the lower bound corresponds to the lower bound on the loglikelihood to maximize, where 1(θ) is the loglikelihood function:

l(θ):=log p(x;θ)=log ∫_{z}p(x,z;θ)dz

In step 905, in-distribution neighborhood generator 302 of in-distribution sample generator 101 estimates the percentiles of a Gaussian variational autoencoder distortion distribution to compute an upper bound for the latent space of the in-distribution neighborhood samples.

As discussed above, the “variational autoencoder distortion,” as used herein, refers to the difference between data points (latent variables) in the latent space and the input data, such as input (x) 202. In one embodiment, the latent variables are Gaussian and hence the variational autoencoder distortion distribution corresponds to a Gaussian distortion. In one embodiment, the median of a distribution corresponds to the value in the middle of the distribution. In one embodiment, the upper bound for the latent space of the in-distribution neighborhood samples corresponds to a user-designated amount or percentage above the median of the distribution. In one embodiment, such a user-designated amount or percentage is provided by an expert, such as a user of computing device 102.

In one embodiment, the lower and upper bounds for the latent space of the in-distribution neighborhood samples are utilized to ensure that the in-distribution samples of the instance of the dataset in latent space are in-distribution and satisfy the distortion constraint.

In step 906, in-distribution neighborhood generator 302 of in-distribution sample generator 101 normalizes the set of latent vectors.

As stated above, “normalizing,” as used herein, refers to changing the values of the latent vectors to a common scale without distorting the differences in the range of values. In one embodiment, such normalization is the I2 normalization, such that the Frobenius norm of the latent vectors is 1. In one embodiment, in-distribution neighborhood generator 302 utilizes various software tools for normalizing the set of latent vectors, including, but not limited to, Flexera® One, Normalyzer, etc.

In step 907, in-distribution neighborhood generator 302 of in-distribution sample generator 101 resamples the normalized latent vectors according to a chi-square distribution (or a truncated chi-square distribution) using the lower bound and the upper bound for the latent space, where the resampled normalized latent vectors correspond to the generated in-distribution neighborhood samples of the instance of the dataset.

As discussed above, the “chi-square distribution,” as used herein, refers to the distribution of a sum of the square of k normalized latent vectors. The “truncated chi-square distribution,” as used herein, refers to performing the chi-square distribution on a truncated distribution of the normalized latent vectors.

In one embodiment, in-distribution neighborhood generator 302 utilizes various software tools for resampling the normalized latent vectors according to a chi-square distribution (or a truncated chi-square distribution) using the lower bound and the upper bound for the latent space, including, but not limited to, SPSS® Statistics, JMP®, JASP, etc.

An example of the generated in-distribution neighborhood samples of the instance of the dataset is shown in FIG. 4.

Returning to FIG. 7, in conjunction with FIGS. 1-6 and 8-9, in step 703, interpretable generator 303 of in-distribution sample generator 101 generates a set of interpretable examples for the in-distribution neighborhood samples using a k-nearest neighbors algorithm in order to explain the black box model's predictions.

In one embodiment, given an in-distribution neighborhood (n( [symbol] | [symbol] )). interpretable generator 303 generates a set of interpretable examples that are closest to the original instance, \hat{x}. In one embodiment, interpretable generator 303 picks the closest k examples that are identified using the k-nearest neighbors algorithm as discussed further below. A more detailed discussion regarding generating a set of representative in-distribution examples using a k-nearest neighbors algorithm in order to explain the black box model's predictions is provided below in connection with FIG. 10.

Referring to FIG. 10, FIG. 10 is a flowchart of a method 1000 for generating a set of representative in-distribution examples in accordance with an embodiment of the present disclosure.

In step 1001, interpretable generator 303 of in-distribution sample generator 101 samples a set of representative examples from the generated in-distribution samples in the latent space that belongs to a class, c. For instance, for each class c, a set of representative examples R in the latent space that belong to class c is sampled.

As discussed above, in one embodiment, interpretable generator 303 samples a set of representative samples from the generated in-distribution samples in the latent space that belongs to a class, c. For instance, for each class c, a set of representative examples R in the latent space that belong to class c is sampled. In one embodiment, such sampling corresponds to randomly sampling representative examples in the generated in-distribution samples in the latent space that belongs to class c. In one embodiment, such sampling is based on criteria established by an expert, such as possessing particular features (e.g., points, lines, edges, objects, areas). A “class,” as used herein, refers to the label or category which provides context.

In step 1002, interpretable generator 303 of in-distribution sample generator 101 computes a set of k-nearest neighbors to the input, such as input (x) 202, in the latent space with respect to the set of representative examples.

As stated above, in one embodiment, input (x) 202 corresponds to an instance of the dataset in the latent space. In one embodiment, interpretable generator 303 computes the set of k-nearest neighbors in the set of representative examples with respect to the input, such as input (x) 202, in the latent space using the k-nearest neighbors algorithm.

In one embodiment, interpretable generator 303 determines the distance between the input, such as input (x) 202, and the other data points in the latent space (i.e., the set of representative samples). In one embodiment, interpretable generator 303 performs one of the following distance measures, such as the Euclidean distance, Manhattan distance, Minkowski distance, Hamming distance, etc., to obtain the distance between the input, such as input (x) 202, and the other data points in the latent space (i.e., the set of representative examples). In one embodiment, interpretable generator 303 implements the k-nearest neighbors algorithm using such distance calculations to identify the set of k-nearest neighbors to the input, such as input (x) 202, in the latent space. In one embodiment, interpretable generator 303 utilizes various software tools for implementing the k-nearest neighbors algorithm, including, but not limited to, MathWorks®, Cognos® Analytics, Netezza®, Planning Analytics, SPSS®, etc.

In step 1003, interpretable generator 303 of in-distribution sample generator 101 generates a set of interpretable (explanation) examples for the in-distribution neighborhood samples from the sampled set of representative examples corresponding to the k-nearest neighbors.

An illustration of generating a set of interpretable (explanation) examples for the in-distribution neighborhood samples using a k-nearest neighbors algorithm is shown in FIG. 5.

In this manner, the principles of the present disclosure utilize variational autoencoders to generate local neighborhoods that satisfy a certain distortion constant. Furthermore, by utilizing the variational autoencoder to generate low-distortion, in-distribution neighborhood samples of an instance of a dataset, the correlations between the features of the neighborhood distribution are able to be captured and a set of representative in-distribution examples for the in-distribution neighborhood samples is able to be generated. As a result, the accuracy of the decision making ability of the post-hoc local explanation method is improved.

Furthermore, the principles of the present disclosure improve the technology or technical field involving artificial intelligence methods. As discussed above, an example of a post-hoc local explanation method is the local interpretable model-agnostic explanation (LIME) method. LIME is a method that fits a surrogate glassbox model around the decision space of any black box model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the black box model behaves in that region. LIME works by perturbing any individual datapoint (perturbations correspond to small changes in the system, such as small changes in the gradients, weights, inputs, etc.) and generating synthetic data which gets evaluated by the black box system. and ultimately used as a training set for the glassbox model. LIME's advantages are that you can interpret an explanation the same way you reason about a linear model, and that it can be used on almost any model. Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method. Furthermore, while such neighborhood distributions are inherently interpretable, the explanations generated may not capture the correlated behaviors of the model. As a result, the correlations between the features (e.g., features created from a time stamp value of an observation) of a neighborhood distribution may not be effectively captured. By not effectively capturing the correlations between the features of the neighborhood distribution, a set of interpretable examples for the in-distribution neighborhood samples cannot be generated in order to explain the black box model's predictions. As a result, there is not currently a means for generating in-distribution samples of a dataset, such as time-series or image data, for the neighborhood distribution to be used by the post-hoc local explanation methods. Furthermore, there is not currently a means for effectively capturing the correlations between the features of the neighborhood distribution or effectively generating a set of representative in-distribution examples in order to explain the black box model's predictions.

Embodiments of the present disclosure improve such technology by training a variational autoencoder to generate in-distribution neighborhood samples. A “variational autoencoder,” as used herein, refers to an artificial neural network architecture which allows statistical inference problems (such as inferring the value of one random variable from another random variable) to be rewritten as statistical optimization problems (i.e., identify the parameter values that minimize an objective function). Variational autoencoders map the input variable to a multivariate latent distribution. In particular, the input data is sampled from a parametrized distribution, and the encoder and decoder are trained jointly such that the output minimizes a reconstruction error. Upon training the variational autoencoder to generate in-distribution neighborhood samples, in-distribution neighborhood samples of an instance of a dataset in latent space that satisfy a distortion constraint are generated using the trained variational autoencoder. A set of interpretable examples for the in-distribution neighborhood samples are then generated using a k-nearest neighbors algorithm. Such interpretable examples are then used to explain the black box model's predictions. As a result, the accuracy of the decision making ability of post-hoc local explanation methods is improved. Furthermore, in this manner, there is an improvement in the technical field involving artificial intelligence methods.

In one embodiment of the present disclosure, a computer-implemented method for utilizing a variational autoencoder for neighborhood sampling comprises training the variational autoencoder to generate in-distribution neighborhood samples. The method further comprises generating, using the trained variational autoencoder, in-distribution neighborhood samples of an instance of a dataset in a latent space that satisfies a distortion constraint. The method additionally comprises generating a set of interpretable examples for the in-distribution neighborhood samples using a k-nearest neighbors algorithm.

Furthermore, in one embodiment of the present disclosure, the variational autoencoder is trained to generate the in-distribution neighborhood samples of the instance of the dataset in the latent space by encoding an input as a distribution over the latent space, where the input comprises an instance of the dataset, sampling a point of the distribution from the latent space, decoding the sampled point which corresponds to an input reconstruction, where the input reconstruction satisfies a minimum distortion level, computing a reconstruction error, and minimizing the reconstruction error.

Additionally, in one embodiment of the present disclosure, the method further comprises encoding the instance of the dataset. The method additionally comprises computing a mean and a standard deviation of the encoded instance.

Furthermore, in one embodiment of the present disclosure, the method additionally comprises sampling a set of latent vectors from a Gaussian distribution with the mean and the standard deviation of the encoded instance.

Additionally, in one embodiment of the present disclosure, the method further comprises receiving a lower bound for the latent space of the in-distribution neighborhood samples. The method additionally comprises estimating percentiles of a Gaussian variational autoencoder distortion distribution to compute an upper bound for the latent space of the in-distribution neighborhood samples. Furthermore, the method comprises normalizing the set of latent vectors. Additionally, the method comprises resampling the normalized latent vectors according to a chi-square distribution using the lower bound for the latent space and the upper bound for the latent space, where the resampled normalized latent vectors correspond to the generated in-distribution neighborhood samples of the instance of the dataset.

Furthermore, in one embodiment of the present disclosure, the method additionally comprises sampling a set of representative examples from the generated in-distribution neighborhood samples in the latent space that belong to a class. The method further comprises computing a set of k-nearest neighbors to the instance of the dataset in the latent space with respect to the set of representative examples. Furthermore, the method comprises generating the set of interpretable examples for the in-distribution neighborhood samples from the sampled set of representative examples corresponding to the k-nearest neighbors.

Additionally, in one embodiment of the present disclosure, the dataset comprises time-series data or image data.

Other forms of the embodiments of the computer-implemented method described above are in a system and in a computer program product.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for utilizing a variational autoencoder for neighborhood sampling, the method comprising:
training said variational autoencoder to generate in-distribution neighborhood samples;
generating, using said trained variational autoencoder, in-distribution neighborhood samples of an instance of a dataset in a latent space that satisfies a distortion constraint; and
generating a set of interpretable examples for said in-distribution neighborhood samples using a k-nearest neighbors algorithm.

2. The method as recited in claim 1, wherein said variational autoencoder is trained to generate said in-distribution neighborhood samples of said instance of said dataset in said latent space by:
encoding an input as a distribution over said latent space, wherein said input comprises an instance of said dataset;
sampling a point of said distribution from said latent space;
decoding said sampled point which corresponds to an input reconstruction, wherein said input reconstruction satisfies a minimum distortion level;
computing a reconstruction error; and
minimizing said reconstruction error.

3. The method as recited in claim 1 further comprising:
encoding said instance of said dataset; and
computing a mean and a standard deviation of said encoded instance.

4. The method as recited in claim 3 further comprising:
sampling a set of latent vectors from a Gaussian distribution with said mean and said standard deviation of said encoded instance.

5. The method as recited in claim 4 further comprising:
receiving a lower bound for said latent space of said in-distribution neighborhood samples;
estimating percentiles of a Gaussian variational autoencoder distortion distribution to compute an upper bound for said latent space of said in-distribution neighborhood samples;
normalizing said set of latent vectors; and
resampling said normalized latent vectors according to a chi-square distribution using said lower bound for said latent space and said upper bound for said latent space, wherein said resampled normalized latent vectors correspond to said generated in-distribution neighborhood samples of said instance of said dataset that satisfy said distortion constraint.

6. The method as recited in claim 1 further comprising:
sampling a set of representative examples from said generated in-distribution neighborhood samples in said latent space that belong to a class;
computing a set of k-nearest neighbors to said instance of said dataset in said latent space with respect to said set of representative examples; and
generating said set of interpretable examples for said in-distribution neighborhood samples from said sampled set of representative examples corresponding to said k-nearest neighbors.

7. The method as recited in claim 1, wherein said dataset comprises time-series data or image data.

8. A computer program product for utilizing a variational autoencoder for neighborhood sampling, the computer program product comprising one or more computer readable storage mediums having program code embodied therewith, the program code comprising programming instructions for:
training said variational autoencoder to generate in-distribution neighborhood samples;
generating, using said trained variational autoencoder, in-distribution neighborhood samples of an instance of a dataset in a latent space that satisfies a distortion constraint; and
generating a set of interpretable examples for said in-distribution neighborhood samples using a k-nearest neighbors algorithm.

9. The computer program product as recited in claim 8, wherein said variational autoencoder is trained to generate said in-distribution neighborhood samples of said instance of said dataset in said latent space by:
encoding an input as a distribution over said latent space, wherein said input comprises an instance of said dataset;
sampling a point of said distribution from said latent space;
decoding said sampled point which corresponds to an input reconstruction, wherein said input reconstruction satisfies a minimum distortion level;
computing a reconstruction error; and
minimizing said reconstruction error.

10. The computer program product as recited in claim 8, wherein the program code further comprises the programming instructions for:
encoding said instance of said dataset; and
computing a mean and a standard deviation of said encoded instance.

11. The computer program product as recited in claim 10, wherein the program code further comprises the programming instructions for:
sampling a set of latent vectors from a Gaussian distribution with said mean and said standard deviation of said encoded instance.

12. The computer program product as recited in claim 11, wherein the program code further comprises the programming instructions for:
receiving a lower bound for said latent space of said in-distribution neighborhood samples;
estimating percentiles of a Gaussian variational autoencoder distortion distribution to compute an upper bound for said latent space of said in-distribution neighborhood samples; 5
normalizing said set of latent vectors; and
resampling said normalized latent vectors according to a chi-square distribution using said lower bound for said latent space and said upper bound for said latent space, wherein said resampled normalized latent vectors correspond to said generated in-distribution neighborhood samples of said instance of said dataset that satisfy said distortion constraint. 10

13. The computer program product as recited in claim 8, wherein the program code further comprises the programming instructions for:
sampling a set of representative examples from said generated in-distribution neighborhood samples in said latent space that belong to a class;
computing a set of k-nearest neighbors to said instance of said dataset in said latent space with respect to said set of representative examples; and
generating said set of interpretable examples for said in-distribution neighborhood samples from said sampled set of representative examples corresponding to said k-nearest neighbors.

14. The computer program product as recited in claim 8, wherein said dataset comprises time-series data or image data.

15. A system, comprising:
a memory for storing a computer program for utilizing a variational autoencoder for neighborhood sampling; and
a processor connected to said memory, wherein said processor is configured to execute program instructions of the computer program comprising:
training said variational autoencoder to generate in-distribution neighborhood samples;
generating, using said trained variational autoencoder, in-distribution neighborhood samples of an instance of a dataset in a latent space that satisfies a distortion constraint; and
generating a set of interpretable examples for said in-distribution neighborhood samples using a k-nearest neighbors algorithm.

16. The system as recited in claim 15, wherein said variational autoencoder is trained to generate said in-distribution neighborhood samples of said instance of said dataset in said latent space by:
encoding an input as a distribution over said latent space, wherein said input comprises an instance of said dataset;
sampling a point of said distribution from said latent space;
decoding said sampled point which corresponds to an input reconstruction, wherein said input reconstruction satisfies a minimum distortion level;
computing a reconstruction error; and
minimizing said reconstruction error.

17. The system as recited in claim 15, wherein the program instructions of the computer program further comprise:
encoding said instance of said dataset; and
computing a mean and a standard deviation of said encoded instance.

18. The system as recited in claim 17, wherein the program instructions of the computer program further comprise:
sampling a set of latent vectors from a Gaussian distribution with said mean and said standard deviation of said encoded instance.

19. The system as recited in claim 18, wherein the program instructions of the computer program further comprise:
receiving a lower bound for said latent space of said in-distribution neighborhood samples;
estimating percentiles of a Gaussian variational autoencoder distortion distribution to compute an upper bound for said latent space of said in-distribution neighborhood samples;
normalizing said set of latent vectors; and
resampling said normalized latent vectors according to a chi-square distribution using said lower bound for said latent space and said upper bound for said latent space, wherein said resampled normalized latent vectors correspond to said generated in-distribution neighborhood samples of said instance of said dataset that satisfy said distortion constraint.

20. The system as recited in claim 15, wherein the program instructions of the computer program further comprise:
sampling a set of representative examples from said generated in-distribution neighborhood samples in said latent space that belong to a class;
computing a set of k-nearest neighbors to said instance of said dataset in said latent space with respect to said set of representative examples; and
generating said set of interpretable examples for said in-distribution neighborhood samples from said sampled set of representative examples corresponding to said k-nearest neighbors.
